(19) United States
(12) Patent Application Publication
(10) Pub. No.: US 2014/0161930 A1
(43) Pub. Date: Jun. 12, 2014

(54) VEGETABLE-BASED NUTRITIONAL PRODUCTS

(71) Applicant: Vivek Dilip Savant, Norton Shores, MI (US)

(72) Inventor: Vivek Dilip Savant, Norton Shores, MI (US)

(73) Assignee: NESTEC S.A., Vevey (CH)

(21) Appl. No.: 14/131,877

(22) PCT Filed: Aug. 2, 2012
(86) PCT No.: PCT/US2012/049303

§ 371 Date: Jan. 9, 2014

Related U.S. Application Data
(60) Provisional application No. 61/514,561, filed on Aug. 3, 2011.

(51) Int. Cl. A23L 1/29

(52) U.S. Cl. CPC A23L 1/296
USPC 426/2; 426/615; 426/629; 426/637; 426/72; 426/61; 426/71

(57) ABSTRACT

The present disclosure is generally directed to homogeneous plastic mass compositions. Specifically, the present dis closure relates to vegetable-based compositions in the form of vegetable or vegetable/fruit leathers. In a general embodiment, nutritional products are provided that include at least about 75% by weight of at least one vegetable, where the product is a homogeneous plastic mass having a water activity ranging from about 0.3 to about 1.0. In another embodiment, nutritional products are provided that include at least about 15% by weight of at least one vegetable and at least about 40% by weight of at least one fruit, where the product is a homogeneous plastic mass having a water activity ranging from about 0.3 to about 1.0. Methods for making and using the nutritional products are also provided by the present disclosure.

### BACKGROUND

The present disclosure relates generally to nutritional products. Specifically, the present disclosure relates to vegetable or vegetable and fruit leathers that may be consumed as a snack, a meal supplement or a small meal.

Fruit leathers are edible products that are substantially made of a fruit mass. Typically, the portion of the fruit mass in the fruit leather product may be from about 50% to about 100% fruit, and the fruit leathers are typically prepared by known methods that include pouring the fruit mass onto a support and reducing the water content of the fruit mass to obtain a leathery condition of the fruit mass, which is then cut into separate products. Fruit leathers provide tasty, nutritious snacks that are easy to consume on-the-go. As such, fruit leathers may be especially beneficial for a busy individual, or children who require easy to consume snacks that taste delicious.

The nutritional guidelines supplied by the Center for Disease Control and Prevention (“CDC”), however, recommend consumption of vegetables in addition to fruit. Though vegetables also provide necessary nutrients, the typical consumer generally finds vegetable-based products to be less appealing and less flavorful than fruit-based products. As a result, vegetable snack products are far less common than fruit snack products because of the inability to provide a great-tasting vegetable snack product that has a taste that is acceptable by many different types of consumers (e.g., small children, busy professionals, etc.).

### SUMMARY

The present disclosure is generally directed to plastic mass compositions. Specifically, the present disclosure relates to vegetable-based compositions in the form of vegetable or vegetable/fruit leathers that may be a bar or a cylinder, or like-shaped pieces of such compositions. In a general embodiment, the present disclosure provides a nutritional product including at least about 75% by weight of at least one vegetable, wherein the product is in the form of a homogeneous plastic mass having a water activity ranging from about 0.3 to about 1.0.

In an embodiment, the nutritional product includes at least about 80%, or at least about 85%, or at least about 90%, or at least about 95% by weight of the vegetable composition. In an embodiment, the nutritional product includes about 100% of the vegetable composition.

In an embodiment, the at least one vegetable is selected from the group consisting of amaranth, arugula, brussels sprouts, cabbage, celery lettuce, radicchio, water cress, spinach mushrooms, peas, beans, beets, carrots, potatoes, radish, rutabaga, turnips, squash, pumpkin, potato, sweet potato, zucchini, or combinations thereof

In an embodiment, the nutritional product comprises a water activity ranging from about 0.5 to about 0.8, or about 0.7.

In an embodiment, the nutritional product includes at least one coloring agent.

In an embodiment, the nutritional product includes at least one flavoring agent. The flavoring agent may be an acidulant. The acidulant may be an edible, non-volatile organic acid.

In an embodiment, the nutritional product includes a source of protein. The source of protein may be selected from the group consisting of dairy based proteins, plant based proteins, animal based proteins, artificial proteins, or combinations thereof. The dairy based proteins may be selected from the group consisting of casein, caseinates, casein hydrolysate, whey, whey hydrolysates, whey concentrates, whey isolates, milk protein concentrate, milk protein isolate, or combinations thereof. The plant based proteins may be selected from the group consisting of soy protein, pea protein, canola protein, wheat and fractionated wheat proteins, corn proteins, zein proteins, rice proteins, oat proteins, potato proteins, peanut proteins, green pea powder, green bean powder, spirulina, proteins derived from vegetables, beans, buckwheat, lentils, pulses, single cell proteins, or combinations thereof.

In an embodiment, the nutritional product includes a source of carbohydrates. The carbohydrates may be selected from the group consisting of sucrose, lactose, glucose, fructose, corn syrup solids, maltodextrin, modified starch, amylose starch, tapioca starch, corn starch or combinations thereof.

In an embodiment, the nutritional product includes a source of fat. The fat may be selected from the group consisting of olive oil, corn oil, sunflower oil, high-oleic sunflower, rapeseed oil, canola oil, hazelnut oil, soy oil, palm oil, coconut oil, blackcurrant seed oil, borage oil, lecithins, milk fat, or combinations thereof.

In an embodiment, the nutritional product includes a source of fiber. The fiber may be selected from the group consisting of galacto-oligosaccharides, fructo-oligosaccharides, fuco-oligosaccharides, xylo-oligosaccharides, palatinose-oligosaccharide, soybean oligosaccharide, gentio-oligosaccharide, inulin, pectin, pectate, alginate, chondroitine, hyaluronic acids, heparine, heparane, sialoglycans, fucoidan, carrageenan, xanthan gum, cellulose, polydextrose, partially hydrolyzed guar gum, guar gum, or combinations thereof.

In an embodiment, the nutritional product includes an amino acid selected from the group consisting of alanine, arginine, asparagine, aspartate, cysteine, glutamate, glutamine, glycine, histidine, hydroxyproline, hydroxyserine, hydroxytyrosine, hydroxylysine, isoleucine, leucine, lysine, methionine, phenylalanine, proline, serine, taurine, threonine, tryptophan, tyrosine, valine, or combinations thereof.

In an embodiment, the nutritional product includes an antioxidant selected from the group consisting of astaxanthin, carotenoids, coenzyme Q10 (“CoQ10”), flavonoids, glutathione, Goji (wolfberry), hesperidin, lactowolfberry, lignan, lutein, lycopene, polyphenols, selenium, vitamin A, vitamin C, vitamin E, zeaxanthin, or combinations thereof.

In an embodiment, the nutritional product includes a source of ω-3 fatty acids, wherein the source of ω-3 fatty acids is selected from the group consisting of fish oil, krill, plant sources containing ω-3 fatty acids, flaxseed, walnut, algae, or combinations thereof. In an embodiment ω-3 fatty acids are selected from the group consisting of α-linolenic acid (“ALA”), docosahexaenoic acid (“DHA”), eicosapentaenoic acid (“EPA”), or combinations thereof.

In an embodiment, the nutritional product includes at least one nucleotide selected from the group consisting of a subunit of deoxyribonucleic acid (“DNA”), a subunit of ribonucleic acid (“RNA”), polymeric forms of DNA and RNA, yeast RNA, or combinations thereof.

In an embodiment, the nutritional product includes a source of phytonutrients selected from the group consisting of flavanoids, allied phenolic compounds, polyphenolic compounds, terpenoids, alkaloids, sulphur-containing compounds, or combinations thereof.

In an embodiment, the nutritional product includes at least one prebiotic selected from the group consisting of acacia gum, alpha glucan, arabinogalactans, beta glucan, dextrans, fructooligosaccharides, fucosyllactose, galactooligosaccharides, galactomannans, gentiooligosaccharides, glucooligosaccharides, guar gum, inulin, isomaltooligosaccharides, lactoneotetraose, lactosucrose, lactulose, levan, maltodextrins, milk oligosaccharides, partially hydrolyzed guar gum, pecticoligosaccharides, resistant starches, retrograded starch, sialooligosaccharides, sialyllactose, soyoligosaccharides, sugar alcohols, xylooligosaccharides, their hydrolysates, or combinations thereof.

In an embodiment, the nutritional product includes a probiotic selected from the group consisting of Aerococcus, Aspergillus, Bacteroides, Bifidobacterium, Candida, Clostridium, Debaromyces, Enterococcus, Fusobacterium, Lactobacillus, Lactococcus, Leuconostoc, Melissococcus, Micrococcus, Mucor, Oenococcus, Pediococcus, Penicillium, Peptostrepococcus, Pichia, Propionibacterium, Pseudocatenulatum, Rhizopus, Saccharomyces, Staphylococcus, Streptococcus, Torulopsis, Weissella, non-replicating microorganisms, or combinations thereof.

In an embodiment, the nutritional product includes a vitamin selected from the group consisting of vitamin A, Vitamin B1 (thiamine), Vitamin B2 (riboflavin), Vitamin B3 (niacin or niacinamide), Vitamin B5 (pantothenic acid), Vitamin B6 (pyridoxine, pyridoxal, or pyridoxamine, or pyridoxine hydrochloride), Vitamin B7 (biotin), Vitamin B9 (folic acid), and Vitamin B12 (various cobalamins; commonly cyanocobalamin in vitamin supplements), vitamin C, vitamin D, vitamin E, vitamin K, K1 and K2 (i.e., MK-4, MK-7), folic acid, biotin, or combinations thereof.

In an embodiment, the nutritional product includes a mineral selected from the group consisting of boron, calcium, chromium, copper, iodine, iron, magnesium, manganese, molybdenum, nickel, phosphorus, potassium, selenium, silicon, tin, vanadium, zinc, or combinations thereof.

In an embodiment, the product is in a solid or semi-solid form having a shape selected from the group consisting of a bar, a cylinder, a sphere, a cube, a star, a prism, a disc, or combinations thereof.

In another embodiment, a nutritional product is provided. The nutritional product includes at least about 15% by weight of at least one vegetable and at least about 40% by weight of at least one fruit. The product is in the form of a homogeneous plastic mass and has a water activity ranging from about 0.3 to about 1.0.

In an embodiment, the nutritional product includes about 20% by weight vegetable, or about 30%, or about 40%, or about 50%, or about 60% vegetable by weight of the nutritional product.

In an embodiment, the nutritional product includes about 50% by weight fruit, or about 60%, or about 70%, or about 80%, or about 85% fruit by weight of the nutritional product.

In an embodiment, the at least one vegetable is selected from the group consisting of amaranth, arugula, brussels sprouts, cabbage, celery lettuce, radicchio, water cress, spinach mushrooms, peas, beans, beets, carrots, potatoes, radish, rutabaga, turnips, squash, pumpkin, potato, sweet potato, zucchini, or combinations thereof.

In an embodiment, the at least one fruit is selected from the group consisting of apples, bananas, coconut, pear, apricot, peach, nectarines, plum, cherry, blackberry, raspberry, mulberry, strawberry, cranberry, blueberry, grapes, grapefruit, kiwi, rhubarb, papaya, melon, watermelon, pomegranate, lemon, lime, mandarin, orange, tangerine, guava, mango, pineapple, tomato, or combinations thereof.

In yet another embodiment, a method for making a nutritional product is provided. The method includes providing a composition including at least one vegetable, drying the vegetable composition to a predetermined moisture content, adding additional ingredients to the vegetable composition to form a mixture, blending the mixture, and extruding the mixture to form a nutritional product. The nutritional product has at least about 75% by weight of the at least one vegetable, and is in the form of a homogeneous plastic mass having a water activity ranging from about 0.3 to about 1.0.

In an embodiment, the at least one vegetable is selected from the group consisting of amaranth, arugula, brussels sprouts, cabbage, celery lettuce, radicchio, water cress, spinach mushrooms, peas, beans, beets, carrots, potatoes, radish, rutabaga, turnips, squash, pumpkin, potato, sweet potato, zucchini, or combinations thereof.

In an embodiment, the composition includes from about 2 to about 8 different vegetables, or from about 3 to about 7, or from about 4 to about 6, or about 5 different vegetables.

In an embodiment, composition includes the vegetables in a form selected from the solid, puree, juice, powder, or combinations thereof.

In an embodiment, the nutritional product comprises at least about 80% by weight of the vegetable composition, or at least about 85%, or at least about 90%, or at least about 95% of the vegetable composition.

In an embodiment, the predetermined moisture content ranges from about 5% to about 20%, or from about 10% to about 15%, or may be about 13%.

In an embodiment, the additional ingredients are selected from the group consisting of flavoring agent, coloring agent, vitamins, minerals, fruit juice, fruit pulp, fruit juice concentrate, fruit solids, organic acid, vegetable juice, vegetable solids, or combinations thereof.

In an embodiment, the mixture is blended for an amount of time ranging from about 1 minute to about 10 minutes, or about 5 minutes.

In an embodiment, the extruder is a cold-extruder.

In an embodiment, the method further includes rolling the extruded mixture to a first predetermined thickness. The first predetermined thickness may range from about 2 mm to about 7 mm, or from about 3 mm to about 6 mm, or may be about 4.5 mm.

In an embodiment, the method further includes rolling the extruded mixture to a second predetermined thickness. The second predetermined thickness ranges from about 1 mm to about 6 mm, or from about 2 mm to about 5 mm, or may be about 3.7 mm.

In an embodiment, the method further includes cooling the nutritional product. The nutritional product is cooled to a temperature that is below about 18° C., or below about 16° C.

In an embodiment, the method further includes cutting the nutritional product, and/or wrapping the nutritional product and/or packaging the nutritional product.

In still yet another embodiment, a method for making a nutritional product is provided. The method includes providing a composition including at least one vegetable and at least one fruit, drying the vegetable and fruit composition to a predetermined moisture content, adding additional ingredients to the vegetable and fruit composition to form a mixture, blending the mixture, and extruding the mixture to form a nutritional product. The nutritional product has at least about 15% by weight of the at least one vegetable and at least about 40% by weight of the at least one fruit. The nutritional product is in the form of a homogeneous plastic mass having a water activity ranging from about 0.3 to about 1.0.

In an embodiment, the at least one vegetable is selected from the group consisting of amaranth, arugula, brussels sprouts, cabbage, celery lettuce, radicchio, water cress, spinach mushrooms, peas, beans, beets, carrots, potatoes, radish, rutabaga, turnips, squash, pumpkin, potato, sweet potato, zucchini, or combinations thereof.

In an embodiment, the at least one fruit is selected from the group consisting of apples, bananas, coconut, pear, apricot, peach, nectarines, plum, cherry, blackberry, raspberry, mulberry, strawberry, cranberry, blueberry, grapes, grapefruit, kiwi, rhubarb, papaya, melon, watermelon, pomegranate, lemon, lime, mandarin, orange, tangerine, guava, mango, pineapple, tomato, or combinations thereof.

In an embodiment, the nutritional product comprises at least about 20% vegetable by weight of the nutritional product, or at least about 30%, or at least about 40%, or at least about 50%, or at least about 60% vegetable by weight of the nutritional product.

In an embodiment, the nutritional product comprises at least about 50%, or at least about 60%, or at least about 70%, or at least about 80%, or at least about 85% fruit by weight of the nutritional product.

In an embodiment, the composition includes from about 2 to about 8 different vegetables, or from about 3 to about 7, or from about 4 to about 6, or about 5 different vegetables.

In an embodiment, the composition includes from about 2 to about 8 different fruits, or from about 3 to about 7, or from about 4 to about 6, or about 5 different fruits.

In an embodiment, the composition includes the vegetables and fruits in a form selected from the solid, puree, juice, powder, or combinations thereof.

One advantage of the present disclosure is to provide improved nutritional snack products including vegetables.

It is another advantage of the present disclosure to provide shelf-stable nutritious snack products including vegetables.

It is yet another advantage of the present disclosure to provide ready-to-eat nutritious snack products including vegetables.

It is still yet another advantage of the present disclosure to provide nutritious meal supplements including vegetables.

Another advantage of the present disclosure is to provide a snack product that provides an increased amount of vegetables, but still tastes delicious.

It is yet another advantage of the present disclosure to provide improved nutritional snack products including vegetables and fruits.

Additional features and advantages are described herein, and will be apparent from the following Detailed Description.

### DETAILED DESCRIPTION

As used in this disclosure and the appended claims, the singular forms “a,” “an” and “the” include plural referents unless the context clearly dictates otherwise. Thus, for example, reference to “a polypeptide” includes a mixture of two or more polypeptides, and the like.

All dosage ranges contained within this application are intended to include all numbers, whole or fractions, contained within said range.

As used herein, “about” is understood to refer to numbers in a range of numerals. Moreover, all numerical ranges herein should be understood to include all integer, whole or fractions, within the range.

As used herein the term “amino acid” is understood to include one or more amino acids. The amino acid can be, for example, alanine, arginine, asparagine, aspartate, citrulline, cysteine, glutamate, glutamine, glycine, histidine, hydroxyproline, hydroxyserine, hydroxytyrosine, hydroxylysine, isoleucine, leucine, lysine, methionine, phenylalanine, proline, serine, taurine, threonine, tryptophan, tyrosine, valine, or combinations thereof.

As used herein, “animal” includes, but is not limited to, mammals, which include but is not limited to, rodents, aquatic mammals, domestic animals such as dogs and cats, farm animals such as sheep, pigs, cows and horses, and humans. Wherein the terms “animal” or “mammal” or their plurals are used, it is contemplated that it also applies to any animals that are capable of the effect exhibited or intended to be exhibited by the context of the passage.

As used herein, the term “antioxidant” is understood to include any one or more of various substances such as beta-carotene (a vitamin A precursor), vitamin C, vitamin E, and selenium) that inhibit oxidation or reactions promoted by Reactive Oxygen Species (“ROS”) and other radical and non-radical species. Additionally, antioxidants are molecules capable of slowing or preventing the oxidation of other molecules. Non-limiting examples of antioxidants include astaxanthin, carotenoids, coenzyme Q10 (“CoQ10”), flavonoids, glutathione, Goji (wolfberry), hesperidin, lactowolfberry, lignan, lutein, lycopene, polyphenols, selenium, vitamin A, vitamin C, vitamin E, zeaxanthin, or combinations thereof.

As used herein, “complete nutrition” includes nutritional products and compositions that contain sufficient types and levels of macronutrients (protein, fats and carbohydrates) and micronutrients to be sufficient to be a sole source of nutrition for the animal to which it is being administered to. Patients can receive 100% of their nutritional requirements from such complete nutritional compositions.

While the terms “individual” and “patient” are often used herein to refer to a human, the invention is not so limited. Accordingly, the terms “individual” and “patient” refer to any animal, mammal or human having or at risk for a medical condition that can benefit from the treatment.

As used herein, sources of ω-3 fatty acids include, for example, fish oil, krill, plant sources of ω-3, flaxseed, walnut, and algae. Examples of ω-3 fatty acids include, for example, α-linolenic acid (“ALA”), docosahexaenoic acid (“DHA”), eicosapentaenoic acid (“EPA”), or combinations thereof.

As used herein, “food grade micro-organisms” means micro-organisms that are used and generally regarded as safe for use in food.

As used herein, “incomplete nutrition” includes nutritional products or compositions that do not contain sufficient levels of macronutrients (protein, fats and carbohydrates) or micronutrients to be sufficient to be a sole source of nutrition for the animal to which it is being administered to. Partial or incomplete nutritional compositions can be used as a nutritional supplement.

As used herein, “mammal” includes, but is not limited to, rodents, aquatic mammals, domestic animals such as dogs and cats, farm animals such as sheep, pigs, cows and horses, and humans. Wherein the term “mammal” is used, it is contemplated that it also applies to other animals that are capable of the effect exhibited or intended to be exhibited by the mammal.

The term “microorganism” is meant to include the bacterium, yeast and/or fungi, a cell growth medium with the microorganism, or a cell growth medium in which microorganism was cultivated.

As used herein, the term “minerals” is understood to include boron, calcium, chromium, copper, iodine, iron, magnesium, manganese, molybdenum, nickel, phosphorus, potassium, selenium, silicon, tin, vanadium, zinc, or combinations thereof.

As used herein, a “non-replicating” microorganism means that no viable cells and/or colony forming units can be detected by classical plating methods. Such classical plating methods are summarized in the microbiology book: James Monroe Jay, et al., Modern food microbiology, 7th edition, Springer Science, New York, N. Y. p. 790 (2005). Typically, the absence of viable cells can be shown as follows: no visible colony on agar plates or no increasing turbidity in liquid growth medium after inoculation with different concentrations of bacterial preparations (non

As used herein, a “nucleotide” is understood to be a subunit of deoxyribonucleic acid (“DNA”), ribonucleic acid (“RNA”), polymeric RNA, polymeric DNA, or combinations thereof. It is an organic compound made up of a nitrogenous base, a phosphate molecule, and a sugar molecule (deoxyribose in DNA and ribose in RNA). Individual nucleotide monomers (single units) are linked together to form polymers, or long chains. Exogenous nucleotides are specifically provided by dietary supplementation. The exogenous nucleotide can be in a monomeric form such as, for example, 5′-Adenosine Monophosphate (“5′-AMP”), 5′-Guanosine Monophosphate (“5′-GMP”), 5′-Cytosine Monophosphate (“5′-CMP”), 5′-Uracil Monophosphate (“5′-UMP”), 5′-Inosine Monophosphate (“5′-IMP”), 5′-Thymine Monophosphate (“5′-TMP”), or combinations thereof. The exogenous nucleotide can also be in a polymeric form such as, for example, an intact RNA. There can be multiple sources of the polymeric form such as, for example, yeast RNA.

“Nutritional products,” or “nutritional compositions,” as used herein, are understood to include any number of optional additional ingredients, including conventional food additives (synthetic or natural), for example one or more acidulants, additional thickeners, buffers or agents for pH adjustment, chelating agents, colorants, emulsifies, excipient, flavor agent, mineral, osmotic agents, a pharmaceutically acceptable carrier, preservatives, stabilizers, sugar, sweeteners, texturizers, and/or vitamins. The optional ingredients can be added in any suitable amount. The nutritional products or compositions may be a source of complete nutrition or may be a source of incomplete nutrition.

As used herein the term “patient” is understood to include an animal, especially a mammal, and more especially a human that is receiving or intended to receive treatment, as it is herein defined.

As used herein, “phytochemicals” or “phytonutrients” are non-nutritive compounds that are found in many foods. Phytochemicals are functional foods that have health benefits beyond basic nutrition, are health promoting compounds that come from plant sources, and may be natural or purified. “Phytochemicals” and “Phytonutrients” refers to any chemical produced by a plant that imparts one or more health benefit on the user. Non-limiting examples of phytochemicals and phytonutrients include those that are:

i) phenolic compounds which include monophenols (such as, for example, apiole, carnosol, carvacrol, dillapiole, rosemarinol); flavonoids (polyphenols) including flavonols (such as, for example, quercetin, fingerol, kaempferol, myricetin, rutin, isorhamnetin), flavanones (such as, for example, fesperidin, naringenin, silybin, eriodictyol), flavones (such as, for example, apigenin, tangeritin, luteolin), flavan-3-ols (such as, for example, catechins, (+)-catechin, (+)-gallocatechin, (−)-epicatechin, (−)-epigallocatechin, (−)-epigallocatechin gallate (EGCG), (−)-epicatechin 3-gallate, theaflavin, theaflavin-3-gallate, theaflavin-3′-gallate, theaflavin-3,3′-digallate, thearubigins), anthocyanins (flavonals) and anthocyanidins (such as, for example, pelargonidin, peonidin, cyanidin, delphinidin, malvidin, petunidin), isoflavones (phytoestrogens) (such as, for example, daidzein (formononetin), genistein (biochanin A), glycitein), dihydroflavonols, chalcones, coumestans (phytoestrogens), and Coumestrol; Phenolic acids (such as: Ellagic acid, Gallic acid, Tannic acid, Vanillin, curcumin); hydroxycinnamic acids (such as, for example, caffeic acid, chlorogenic acid, cinnamic acid, ferulic acid, coumarin); lignans (phytoestrogens), silymarin, secoisolariciresinol, pinoresinol and lariciresinol); tyrosol esters (such as, for example, tyrosol, hydroxytyrosol, oleocanthal, oleuropein); stilbenoids (such as, for example, resveratrol, pterostilbene, piceatannol) and punicalagins;

ii) terpenes (isoprenoids) which include carotenoids (tetraterpenoids) including carotenes (such as, for example, α-carotene, β-carotene, γ-carotene, δ-carotene, lycopene, neurosporene, phytofluene, phytoene), and xanthophylls (such as, for example, canthaxanthin, cryptoxanthin, aeaxanthin, astaxanthin, lutein, rubixanthin); monoterpenes (such as, for example, limonene, perillyl alcohol); saponins; lipids including: phytosterols (such as, for example, campesterol, beta sitosterol, gamma sitosterol, stigmasterol), tocopherols (vitamin E), and omega-3, 6, and 9 fatty acids (such as, for example, gamma-linolenic acid); triterpenoid (such as, for example, oleanolic acid, ursolic acid, betulinic acid, moronic acid);

iii) betalains which include Betacyanins (such as: betanin, isobetanin, probetanin, neobetanin); and betaxanthins (non glycosidic versions) (such as, for example, indicaxanthin, and vulgaxanthin);

iv) organosulfides, which include, for example, dithiolthiones (isothiocyanates) (such as, for example, sulphoraphane); and thiosulphonates (allium compounds) (such as, for example, allyl methyl trisulfide, and diallyl sulfide), indoles, glucosinolates, which include, for example, indole-3-carbinol; sulforaphane; 3,3′-diindolylmethane; sinigrin; allicin; alliin; allyl isothiocyanate; piperine; syn-propanethial-S-oxide;

v) protein inhibitors, which include, for example, protease inhibitors;

vi) other organic acids which include oxalic acid, phytic acid (inositol hexaphosphate); tartaric acid; and anacardic acid; or

vii) combinations thereof.

As used herein, a “plastic mass” is a food composition that contains at least one vegetable and that flows when force is applied but regains its original consistency (not necessarily its shape) when the force is removed.

As used herein, a “prebiotic” is a food substance that selectively promotes the growth of beneficial bacteria or inhibits the growth or mucosal adhesion of pathogenic bacteria in the intestines. They are not inactivated in the stomach and/or upper intestine or absorbed in the gastrointestinal tract of the person ingesting them, but they are fermented by the gastrointestinal microflora and/or by probiotics. Prebiotics are, for example, defined by Glenn R. Gibson and Marcel B. Roberfroid, “Dietary Modulation of the Human Colonic Microbiota: Introducing the Concept of Prebiotics,” J. Nutr., 125: 1401-1412 (1995). Non-limiting examples of prebiotics include acacia gum, alpha glucan, arabinogalactans, beta glucan, dextrans, fructooligosaccharides, fucosyllactose, galactooligosaccharides, galactomannans, gentiooligosaccharides, glucooligosaccharides, guar gum, inulin, isomaltooligosaccharides, lactoneotetraose, lactosucrose, lactulose, levan, maltodextrins, milk oligosaccharides, partially hydrolyzed guar gum, pecticoligosaccharides, resistant starches, retrograded starch, sialooligosaccharides, sialyllactose, soyoligosaccharides, sugar alcohols, xylooligosaccharides, or their hydrolysates, or combinations thereof.

As used herein, probiotic micro-organisms (hereinafter “probiotics”) are food-grade microorganisms (alive, including semi-viable or weakened, and/or non-replicating), metabolites, microbial cell preparations or components of microbial cells that could confer health benefits on the host when administered in adequate amounts, more specifically, that beneficially affect a host by improving its intestinal microbial balance, leading to effects on the health or well-being of the host. See, Salminen S, Ouwehand A. Benno Y. et al., “Probiotics: how should they be defined?,” Trends Food Sci. Technol., 10, 107-10 (1999). In general, it is believed that these micro-organisms inhibit or influence the growth and/or metabolism of pathogenic bacteria in the intestinal tract. The probiotics may also activate the immune function of the host. For this reason, there have been many different approaches to include probiotics into food products. Non-limiting examples of probiotics include Aerococcus, Aspergillus, Bacteroides, Bifidobacterium, Candida, Clostridium, Debaromyces, Enterococcus, Fusobacterium, Lactobacillus, Lactococcus, Leuconostoc, Melissococcus, Micrococcus, Mucor, Oenococcus, Pediococcus, Penicillium, Peptostrepococcus, Pichia, Propionibacterium, Pseudocatenulatum, Rhizopus, Saccharomyces, Staphylococcus, Streptococcus, Torulopsis, Weissella, or combinations thereof.

The terms “protein,” “peptide,” “oligopeptides” or “polypeptide,” as used herein, are understood to refer to any composition that includes, a single amino acids (monomers), two or more amino acids joined together by a peptide bond (dipeptide, tripeptide, or polypeptide), collagen, precursor, homolog, analog, mimetic, salt, prodrug, metabolite, or fragment thereof or combinations thereof. For the sake of clarity, the use of any of the above terms is interchangeable unless otherwise specified. It will be appreciated that polypeptides (or peptides or proteins or oligopeptides) often contain amino acids other than the 20 amino acids commonly referred to as the 20 naturally occurring amino acids, and that many amino acids, including the terminal amino acids, may be modified in a given polypeptide, either by natural processes such as glycosylation and other post-translational modifications, or by chemical modification techniques which are well known in the art. Among the known modifications which may be present in polypeptides of the present invention include, but are not limited to, acetylation, acylation, ADP-ribosylation, amidation, covalent attachment of a flavanoid or a heme moiety, covalent attachment of a polynucleotide or polynucleotide derivative, covalent attachment of a lipid or lipid derivative, covalent attachment of phosphatidylinositol, cross-linking, cyclization, disulfide bond formation, demethylation, formation of covalent cross-links, formation of cystine, formation of pyroglutamate, formylation, gamma-carboxylation, glycation, glycosylation, glycosylphosphatidyl inositol (“GPI”) membrane anchor formation, hydroxylation, iodination, methylation, myristoylation, oxidation, proteolytic processing, phosphorylation, prenylation, racemization, selenoylation, sulfation, transfer-RNA mediated addition of amino acids to polypeptides such as arginylation, and ubiquitination. The term “protein” also includes “artificial proteins” which refers to linear or non-linear polypeptides, consisting of alternating repeats of a peptide.

Non-limiting examples of proteins include dairy based proteins, plant based proteins, animal based proteins and artificial proteins. Dairy based proteins may be selected from the group consisting of casein, caseinates, casein hydrolysate, whey, whey hydrolysates, whey concentrates, whey isolates, milk protein concentrate, milk protein isolate, or combinations thereof. Plant based proteins include, for example, soy protein (e.g., all forms including concentrate and isolate), pea protein (e.g., all forms including concentrate and isolate), canola protein (e.g., all forms including concentrate and isolate), other plant proteins that commercially are wheat and fractionated wheat proteins, corn and it fractions including zein, rice, oat, potato, peanut, and any proteins derived from beans, buckwheat, lentils, pulses, single cell proteins, or combinations thereof. Animal based proteins may be selected from the group consisting of beef, poultry, fish, lamb, seafood, or combinations thereof

As used herein, a “synbiotic” is a supplement that contains both a prebiotic and a probiotic that work together to improve the microflora of the intestine.

As used herein the term “vitamin” is understood to include any of various fat-soluble or water-soluble organic substances (non-limiting examples include vitamin A, Vitamin B1 (thiamine), Vitamin B2 (riboflavin), Vitamin B3 (niacin or niacinamide), Vitamin B5 (pantothenic acid), Vitamin B6 (pyridoxine, pyridoxal, or pyridoxamine, or pyridoxine hydrochloride), Vitamin B7 (biotin), Vitamin B9 (folic acid), and Vitamin B12 (various cobalamins; commonly cyanocobalamin in vitamin supplements), vitamin C, vitamin D, vitamin E, vitamin K, K1 and K2 (i.e. MK-4, MK-7), folic acid and biotin) essential in minute amounts for normal growth and activity of the body and obtained naturally from plant and animal foods or synthetically made, pro-vitamins, derivatives, analogs.

The present disclosure is generally directed to homogeneous, plastic mass compositions. Specifically, the present disclosure relates to vegetable-based compositions in the form of vegetable or vegetable/fruit leathers that may be a bar or a cylinder, or like-shaped pieces of such compositions. As described above, fruit leathers are edible products that are substantially made of a fruit mass. Typically, the fruit leathers are prepared by known methods that include pouring a fruit mass onto a support and reducing the water content of the fruit mass to obtain a leathery condition of the fruit mass, which is then cut into separate products. Fruit leathers are beneficial for consumers because the products deliver the healthy nutrients of the included fruits in an easy to consume and delicious manner.

Applicant has developed a vegetable leather that provides a consumer with the beneficial nutrients contained in vegetables, while being in a dry, shelf-stable, ready-to-eat form that is appealing for consumers. Applicant has also discovered that, when combined with an amount of fruit, the taste of vegetables is decreased, yet the product is still able to deliver the healthy nutrients of the vegetables and fruits to the consumer. The skilled artisan will appreciate that the “product(s)” of the present disclosure refer to either (i) a vegetable leather or (ii) a vegetable and fruit leather in accordance with the present disclosure.

The products of the present disclosure may be marketed, for example, as a snack product or a meal supplement, thereby serving as a source of incomplete nutrition. The skilled artisan will appreciate, however, that the presently disclosed products are not limited to these forms of administration and may, for example, be formulated to serve as a source of complete nutrition or as a meal (e.g., a breakfast bar).

To make the presently disclose products, a vegetable mass and/or a vegetable/fruit mass is typically dried and cut to size. The masses may have other ingredients added thereto during the preparation of the products. The vegetable mass used to produce a vegetable leather may be, for example, a vegetable puree, natural

The products of the present disclosure may have a water activity (“A_{w}”), the degree to which water is bound in the product, in the range from about 0.3 to about 1.0, or from about 0.5 to about 0.8, or about 0.7. As is known in the art, a product with a water activity that is too low may be too tough for a consumer to properly chew, while a product with a water activity that is too high may experience microbial instability.

Any known vegetable may be used in the presently disclosed products including, but not limited to amaranth, arugula, brussels sprouts, cabbage, celery lettuce, radicchio, water cress, spinach mushrooms, peas, beans, beets, carrots, potatoes, radish, rutabaga, turnips, squash, pumpkin, potato, sweet potato, zucchini, or combinations thereof. Similarly, any known fruit may be used in the presently disclosed products including, but not limited to apples, bananas, coconut, pear, apricot, peach, nectarines, plum, cherry, blackberry, raspberry, mulberry, strawberry, cranberry, blueberry, grapes, grapefruit, kiwi, rhubarb, papaya, melon, watermelon, pomegranate, lemon, lime, mandarin, orange, tangerine, guava, mango, pineapple, tomato, or combinations thereof. The skilled artisan will appreciate that the vegetables and fruits of the presently disclosed products are not limited to these above-mentioned examples.

Each product of the present disclosure may include a large amount of vegetables or vegetables and fruit. For example, a vegetable leather may include from about 50% to about 100% vegetables, or from about 75% to about 98% vegetables, or from about 85% to about 95% vegetables. A vegetable leather may include, for example, at least about 80% vegetables by weight of the nutritional product, or at least about 85%, or at least about 90%, or at least about 95%, or about 100%. A vegetable leather may include any number of different vegetables including, for example, 1, 2, 3, 4, 5, 6, 7, 8 or more different types of vegetables.

In another embodiment wherein the product is a vegetable/fruit leather, the product may include from about 20% vegetable and 80% fruit to about 50% vegetable and about 50% fruit. In an embodiment, each product provides a full serving of fruits and vegetables. A vegetable/fruit leather may include about 20%, or about 30%, or about 40%, or about 50%, or about 60% vegetables by weight, and about 50%, or about 60%, or about 70%, or about 80%, or about 85% fruits by weight. A vegetable/fruit leather may include any number of different vegetables including, for example, 1, 2, 3, 4, 5, 6, 7, 8 or more different types of vegetables, and any number of different fruits including, for example, 1, 2, 3, 4, 5, 6, 7, 8 or more different types of fruits.

In an example formulation, a vegetable/fruit leather may include about 50% apple and about 50% sweet potato. In another example, a vegetable/fruit leather may include about 70% apple and about 30% sweet potato. Other examples include, but are not limited to about 50% apple and about 50% butternut squash, about 70% apple and about 30% butternut squash, and about 80% apple and about 20% carrot powder.

In an embodiment, the vegetable and/or vegetable/fruit leathers of the present disclosure do not include any added sugars, fats, starches, or other non-natural ingredients. In other, words, the vegetable and/or vegetable/fruit leathers of the present disclosure may be all natural.

Alternatively, the vegetable and/or vegetable/fruit leathers of the present disclosure may include added ingredients such as sweetening agents, flavoring agents, coloring agents, glucose, pectin, fructose, etc. The colors may include known dyes and/or coloring agents. For example, a red color may be imparted to the vegetable and/or vegetable/fruit leathers of the present disclosure by F.D.&C. Red No. 40. The coloring agent may be used in any amount known in the art such as, for example, from about 0.01% to about 5.0%, or from about 0.2% to about 2.5%, or from about 0.3% to about 1%.

The flavoring agents may include an flavoring agent that provides enhanced flavor to the vegetable and/or vegetable/fruit leathers of the present disclosure. In an embodiment, the flavoring agent may be an acidulant and may be edible organic acids and water soluble salts thereof, which may be selected from the

In an embodiment, fruit juices may be added to the leather products for flavor purposes. For example, apple juice, orange juice, strawberry juice, lemon juice, tomato juice, blueberry juice, etc., may be added to the leathers to provide additional flavoring. The products may include added fruit juices in any amount that provides desirable flavoring but does not destroy the physical characteristics of the leather product. The fruit juice may be present in the products from about 0.1% to about 5.0% by weight, or from about 0.5% to about 4.0%, or about 1.0% to about 3.0%, or about 2.0%.

The products may also include fiber or a blend of different types of fiber. The fiber blend may contain a mixture of soluble and insoluble fibers. Soluble fibers may include, for example, fructooligosaccharides, acacia gum, inulin, etc. Insoluble fibers may include, for example, pea outer fiber.

In an embodiment, the nutritional products include a source of protein. The protein source may be dietary protein including, but not limited to animal protein (such as milk protein, meat protein or egg protein), vegetable protein (such as soy protein, wheat protein, rice protein, and pea protein), or combinations thereof. In an embodiment, the protein is selected from the group consisting of whey, chicken, corn, caseinate, wheat, flax, soy, carob, pea or combinations thereof.

The products of the present disclosure may also include a source of carbohydrates. Any suitable carbohydrate may be used in the present products including, but not limited to, sucrose, lactose, glucose, fructose, corn syrup solids, maltodextrin, modified starch, amylose starch, tapioca starch, corn starch or combinations thereof.

A source of fat may also be included in the present products. The source of fat may include any suitable fat or fat mixture. For example, the fat source may include, but is not limited to, vegetable fat (such as olive oil, corn oil, sunflower oil, high-oleic sunflower, rapeseed oil, canola oil, hazelnut oil, soy oil, palm oil, coconut oil, blackcurrant seed oil, borage oil, lecithins, and the like), animal fats (such as milk fat), or combinations thereof. The source of fat may also be less refined versions of the fats listed above (e.g., olive oil for polyphenol content).

In an embodiment, the products further include one or more prebiotics. Non-limiting examples of prebiotics include acacia gum, alpha glucan, arabinogalactans, beta glucan, dextrans, fructooligosaccharides, fucosyllactose, galactooligosaccharides, galactomannans, gentiooligosaccharides, glucooligosaccharides, guar gum, inulin, isomaltooligosaccharides, lactoneotetraose, lactosucrose, lactulose, levan, maltodextrins, milk oligosaccharides, partially hydrolyzed guar gum, pecticoligosaccharides, resistant starches, retrograded starch, sialooligosaccharides, sialyllactose, soyoligosaccharides, sugar alcohols, xylooligosaccharides, their hydrolysates, or combinations thereof.

The products may further include one or more probiotics. Non-limiting examples of probiotics include Aerococcus, Aspergillus, Bacteroides, Bifidobacterium, Candida, Clostridium, Debaromyces, Enterococcus, Fusobacterium, Lactobacillus, Lactococcus, Leuconostoc, Melissococcus, Micrococcus, Mucor, Oenococcus, Pediococcus, Penicillium, Peptostrepococcus, Pichia, Propionibacterium, Pseudocatenulatum, Rhizopus, Saccharomyces, Staphylococcus, Streptococcus, Torulopsis, Weissella, non-replicating microorganisms, or combinations thereof.

One or more amino acids may also be present in the products of the present disclosure. Non-limiting examples of amino acids include alanine, arginine, asparagine, aspartate, citrulline, cysteine, glutamate, glutamine, glycine, histidine, hydroxyproline, hydroxyserine, hydroxytyrosine, hydroxylysine, isoleucine, leucine, lysine, methionine, phenylalanine, proline, serine, taurine, threonine, tryptophan, tyrosine, valine, or combinations thereof.

One or more antioxidants may also be present in the products of the present disclosure. Non-limiting examples of antioxidants include astaxanthin, carotenoids, coenzyme Q10 (“CoQ10”), flavonoids, glutathione, Goji (wolfberry), hesperidin, lactowolfberry, lignan, lutein, lycopene, polyphenols, selenium, vitamin A, vitamin C, vitamin E, zeaxanthin, or combinations thereof.

The nutritional compositions may include a source of ω-3 and/or ω-6 fatty acids. Examples of sources of ω-3 fatty acids include, for example, fish oil, krill, plant sources of ω-3, flaxseed, walnut, and algae. Non-limiting examples of ω-3 fatty acids include α-linolenic acid (“ALA”), docosahexaenoic acid (“DHA”), and eicosapentaenoic acid (“EPA”). Non-limiting examples of ω-6 fatty acids include linoleic acid (“LA”), arachidonic acid (“ARA”).

At least one nucleotide may also be included in the products of the present disclosure. The at least one nucleotide may be selected from the group consisting of a subunit of deoxyribonucleic acid (“DNA”), a subunit of ribonucleic acid (“RNA”), polymeric forms of DNA and RNA, yeast RNA, or combinations thereof. The at least one nucleotide is an exogenous nucleotide.

In an embodiment, the nutritional products include a source of phytochemicals. Phytochemicals are non-nutritive compounds that are found in many fruits and vegetables, among other foods. There are thousands of phytochemicals that can be categorized generally into three main groups. The first group is flavonoids and allied phenolic and polyphenolic compounds. The second group is terpenoids, e.g., carotenoids and plant sterols. The third group is alkaloids and sulfur containing compounds. Phytochemicals are active in the body and, in general, act similarly to antioxidants. They also appear to play beneficial roles in inflammatory processes, clot formation, asthma, and diabetes. Researchers have theorized that to receive the most benefit from consumption of phytochemicals, they should be consumed as part of whole foods, because of the complex, natural combination and potentially synergistic effects. This may partially explain the health benefits associated with consumption of whole fruits and vegetables. Increased intake of fruits and vegetables is associated with reduced risk of many chronic diseases. In order to enhance the phytochemical profile of the present nutritional products, in an embodiment, the products include various fruits and vegetables containing these compounds.

The products of the present disclosure may also include a source of vitamins and/or a source of minerals. Non-limiting examples of vitamins may include, for example, vitamin A, Vitamin B1 (thiamine), Vitamin B2 (riboflavin), Vitamin B3 (niacin or niacinamide), Vitamin B5 (pantothenic acid), Vitamin B6 (pyridoxine, pyridoxal, or pyridoxamine, or pyridoxine hydrochloride), Vitamin B7 (biotin), Vitamin B9 (folic acid), and Vitamin B12 (various cobalamins; commonly cyanocobalamin in vitamin supplements), vitamin C, vitamin D, vitamin E, vitamin K, K1 and K2 (i.e., MK-4, MK-7), folic acid, biotin, or combinations thereof. Non-limiting examples of minerals may include boron, calcium, chromium, copper, iodine, iron, magnesium, manganese, molybdenum, nickel, phosphorus, potassium, selenium, silicon, tin, vanadium, zinc, or combinations thereof.

The products of the present disclosure may have any shape and size known in the art. For example, a vegetable and/or vegetable/fruit composition may be extruded as a rope so that a final leather product has a substantially cylindrical shape (e.g., substantially three-dimensional). Alternatively, a vegetable and/or vegetable/fruit composition may be extruded using a smaller diameter die, so that a final leather product has a string-like shape with a diameter that is smaller than a leather rope. In another embodiment, a vegetable and/or vegetable/fruit composition may be extruded into a sheet that can be cut into separate products (e.g., substantially two-dimensional). As such, the skilled artisan will appreciate that the products may have a shape selected from the group consisting of a bar, a cylinder, a sphere, a cube, a star, a prism, a disc, or combinations thereof. The skilled artisan will also appreciate that the products of the present disclosure are not limited by the shapes listed above, and may have any shape known in the art.

In an embodiment where the leather products are formed from a dried sheet of a vegetable and/or vegetable/fruit composition, the leather products may have a thickness from about 1 mm to about 5 mm, or from about 2 mm to about 4 mm, or about 3.7 mm. The leather products may also be continuously cut lengthwise into strips having widths from about 10 mm to about 50 mm, or from about 20 mm to about 40 mm, or about 30 mm. The leather products can also be cross-cut to a length from about 55 mm to about 95 mm, or about 65 mm to about 85 mm, or about 75 mm.

The vegetable and/or vegetable fruit leather products of the present disclosure may be manufactured using blenders and extruders. For example, a vegetable and/or a vegetable/fruit composition may be poured onto trays and placed in dollies or racks. The vegetable and/or a vegetable/fruit compositions may have any form include, for example, puree, juice, powder, solids, concentrates, or any combination thereof. The vegetable and/or a vegetable/fruit compositions are dried to a final moisture that is between about 10% and about 20%. In an embodiment, the vegetable and/or a vegetable/fruit compositions are dried to a leather consistency having a final moisture of about 13%. The dried vegetable and/or a vegetable/fruit leathers are then transferred to a ribbon blender, where additional liquid and/or dry ingredients are added such as, for example, fruit juice concentrate, flavor, color, vitamin C, etc. The resulting mixture may be blended for an amount of time from about 1 minute to about 10 minutes, or for about 5 minutes.

The mixture of the leathers and additional ingredients may then be conveyed to an extruder. The skilled artisan will appreciate that the type of extruder used will vary depending on the desired product shape or form. For example, different extruders or extruder dies will be used to obtain a vegetable and/or vegetable/fruit rope, as opposed to a vegetable and/or vegetable/fruit sheet, etc.

The extruded mixture may then be passed through a first roller stand to create a first sheet having a desired predetermined thickness. In an embodiment, the thickness of the first sheet may be from about 2 mm to about 7 mm, or from about 3 mm to about 6 mm, or about 4.5 mm. The dried vegetable and/or vegetable/fruit sheet may then be passed through a second roller stand to create a second sheet having thickness that is smaller than the first sheet (e.g., a second predetermined thickness). In an embodiment, the thickness of the second sheet may be from about 1 mm to about 5 mm, or from about 2 mm to about 4 mm, or about 3.7 mm.

The nutritional product that exits the extruder may then be cooled in a cooling tunnel to a temperature that is below about 15-20° C., or below about 16-18° C. The cooled nutritional product can be continuously cut lengthwise into strips having widths from about 10 mm to about 50 mm, or from about 20 mm to about 40 mm, or about 30 mm. The cooled nutritional product can also be cross-cut to a length from about 55 mm to about 95 mm, or about 65 mm to about 85 mm, or about 75 mm. After being cut, the nutritional product may be wrapped and packaged within a retail container. The nutritional product may be packaged in the retail container in any number. In an embodiment, 5 nutritional product are packaged in the retail container.

Method for making nutritional products are also provided by the present disclosure. For example, in an embodiment, a method for making a nutritional product is provided and includes providing a composition including at least one vegetable, drying the vegetable composition to a predetermined moisture content, adding additional ingredients to the vegetable composition to form a mixture, blending the mixture, and extruding the mixture to form a nutritional product. The nutritional product has at least about 75% by weight of the at least one vegetable, and is in the form of a homogeneous plastic mass having a water activity ranging from about 0.3 to about 1.0.

In another embodiment, a method for making a nutritional product is provided. The method includes providing a composition including at least one vegetable and at least one fruit, drying the vegetable and fruit composition to a predetermined moisture content, adding additional ingredients to the vegetable and fruit composition to form a mixture, blending the mixture, and extruding the mixture to form a nutritional product. The nutritional product has at least about 15% by weight of the at least one vegetable and at least about 40% by weight of the at least one fruit. The nutritional product is in the form of a homogeneous plastic mass having a water activity ranging from about 0.3 to about 1.0.

Methods of administering the products of the present disclosure are also provided. For example, in an embodiment, a method includes administering to an individual a nutritional product having at least about 75% by weight of at least one vegetable, wherein the product is in the form of a homogeneous plastic mass having a water activity ranging from about 0.3 to about 1.0. Another method includes administering to an individual a nutritional product having at least about 15% by weight of at least one vegetable and at least about 40% by weight of at least one fruit, wherein the product is in the form of a homogeneous plastic mass having a water activity ranging from about 0.3 to about 1.0.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A nutritional product comprising:
at least about 75% by weight of at least one vegetable, wherein the product is in the form of a homogeneous plastic mass having a water activity ranging from about 0.3 to about 1.0.

2. The nutritional product according to claim 1, wherein the at least one vegetable is selected from the group consisting of amaranth, arugula, brussels sprouts, cabbage, celery lettuce, radicchio, water cress, spinach mushrooms, peas, beans, beets, carrots, potatoes, radish, rutabaga, turnips, squash, pumpkin, potato, sweet potato, zucchini, and combinations thereof.

3. The nutritional product according to claim 1, further comprising: at least one coloring agent; at least one flavoring agent; at least one source of protein; at least one source of carbohydrates; at least one source of fat; at least one amino acid; at least one antioxidant; at least one source of ω-3 fatty acids; at least one nucleotide; at least one source of phytonutrients; at least one prebiotic; at least one probiotic; at least one vitamin; at least one mineral; at least one fruit; or combinations thereof.

4. The nutritional product according to claim 1, wherein the product is in a solid or semi-solid form having a shape selected from the group consisting of a bar, a cylinder, a sphere, a cube, a star, a prism, a disc, and combinations thereof.

5. A nutritional product comprising:
at least about 15% by weight of at least one vegetable and at least about 40% by weight of at least one fruit, wherein the product is in the form of a homogeneous plastic mass having a water activity ranging from about 0.3 to about 1.0.

6. The nutritional product according to claim 5, wherein the at least one vegetable is selected from the group consisting of amaranth, arugula, brussels sprouts, cabbage, celery lettuce, radicchio, water cress, spinach mushrooms, peas, beans, beets, carrots, potatoes, radish, rutabaga, turnips, squash, pumpkin, potato, sweet potato, zucchini, and combinations thereof.

7. The nutritional product according to claim 5, wherein the at least one fruit is selected from the group consisting of apples, bananas, coconut, pear, apricot, peach, nectarines, plum, cherry, blackberry, raspberry, mulberry, strawberry, cranberry, blueberry, grapes, grapefruit, kiwi, rhubarb, papaya, melon, watermelon, pomegranate, lemon, lime, mandarin, orange, tangerine, guava, mango, pineapple, tomato, and combinations thereof.

8. The nutritional product according to claim 5, further comprising: at least one coloring agent; at least one flavoring agent; at least one source of protein; at least one source of carbohydrates; at least one source of fat; at least one amino acid; at least one antioxidant; at least one source of ω-3 fatty acids; at least one nucleotide; at least one source of phytonutrients; at least one prebiotic; at least one probiotic; at least one vitamin; at least one mineral; or combinations thereof.

9. The nutritional product according to claim 5, wherein the product is in a solid or semi-solid form having a shape selected from the group consisting of a bar, a cylinder, a sphere, a cube, a star, a prism, a disc, and combinations thereof.

10. A method for making a nutritional product, the method comprising:
providing a composition including at least one vegetable;
drying the vegetable composition to a predetermined moisture content;
adding additional ingredients to the vegetable composition to form a mixture; blending the mixture; and
extruding the mixture to form a nutritional product, wherein the nutritional product has at least about 75% by weight of the at least one vegetable, and wherein the nutritional product is in the form of a homogeneous plastic mass having a water activity ranging from about 0.3 to about 1.0.

11. The method according claim 10, wherein the nutritional product is selected from the group claimed in claims 1 to claim 4.

12. The method according claim 10, wherein the composition includes from about 2 to about 8 different vegetables.

13. The method according claim 10, wherein the at least one vegetable of the composition is in a form selected from the solid, puree, juice, powder, and combinations thereof.

14. The method according claim 10, wherein the additional ingredients are selected from the group consisting of flavoring agent, coloring agent, vitamins, minerals, fruit juice, fruit pulp, fruit juice concentrate, fruit solids, organic acid, vegetable juice, vegetable solids, protein, carbohydrate, fat, amino acid, antioxidant, ω-3 fatty acid, nucleotide; phytonutrient, prebiotic, probiotic, and combinations Thereof.

15. The method according claim 10, further comprising at least one of:
rolling the extruded mixture to a first predetermined thickness from about 2 mm to about 7 mm;
rolling the extruded mixture to a second predetermined thickness from about 1 mm to about 6 mm;
cooling the nutritional product to below about 18° C.;
cutting the nutritional product;
wrapping the nutritional product;
packaging the nutritional product;
and combinations thereof.

16. A method for making a nutritional product, the method comprising:
providing a composition including at least one vegetable and at least one fruit;
drying the vegetable and fruit composition to a predetermined moisture content;
adding additional ingredients to the vegetable and fruit composition to form a mixture;
blending the mixture; and
extruding the mixture to form a nutritional product, wherein the nutritional product has at least about 15% by weight of the at least one vegetable and at least about 40% by weight of the at least one fruit, and wherein the product is in the form of a homogeneous plastic mass having a water activity ranging from about 0.3 to about 1.0.

17. The method according claim 16, wherein the nutritional product is selected from the group claimed in claims 5 to claim 9.

18. The method according claim 16, wherein the composition includes from about 2 to about 16 different vegetables and fruits.

19. The method according claim 16, wherein the at least one vegetable and the at least one fruit of the composition is in a form selected from the solid, puree, juice, powder, and combinations thereof.

20. The method according claim 16, wherein the additional ingredients are selected from the group consisting of flavoring agent, coloring agent, vitamins, minerals, fruit juice, fruit pulp, fruit juice concentrate, fruit solids, organic acid, vegetable juice, vegetable solids, protein, carbohydrate, fat, amino acid, antioxidant, ω-3 fatty acid, nucleotide; phytonutrient, prebiotic, probiotic, and combinations thereof.

21. The method according claim 16, further comprising at least one of:
rolling the extruded mixture to a first predetermined thickness from about 2 mm to about 7 mm;
rolling the extruded mixture to a second predetermined thickness from about 1 mm to about 6 mm;
cooling the nutritional product to below about 18° C.;
cutting the nutritional product;
wrapping the nutritional product;
packaging the nutritional product;
and combinations thereof.

22. A method for providing a nutritional product to an individual in need of same, the method comprising:
providing a nutritional product selected from the group claimed in claim 1 to claim 9; and
administering the nutritional product to an individual in need of same.

23. A method for providing a nutritional product to an individual in need of same, the method comprising:
providing a nutritional product made by the method selected from the group claimed in claim 10 to claim 21; and
administering the nutritional product to an individual in need of same.
